(19) United States
(12) Patent Application Publication
(10) Pub. No.: US 2010/0059493 A1
(43) Pub. Date: Mar. 11, 2010

(54) INDUCTION HEATED, HOT WIRE WELDING

(76) Inventor: Michael D. McAninch, Goode, VA (US)

Correspondence Address: BABCOCK & WILCOX TECHNICAL SERVICES GROUP, INC.;INTELLECTUAL PROPERTY DEPT (BVCB2K), 20 S. VAN BUREN AVENUE, BARBERTON, OH, 44203, US

(21) Appl. No.: 12/619,032

(22) Filed: Nov. 16, 2009

Related U.S. Application Data
(63) Continuation-in-part of application No. 11/755,795, filed on May 31, 2007, now abandoned.

(51) Int. Cl. B23K 9/00

(52) U.S. Cl. 219/137 PS

(57) ABSTRACT

A hot wire welding process. An induction coil is used to preheat the filler metal wire prior to its entering the welding puddle/arc region. An induction coil is placed in close proximity to the welding arc. The filler wire is guided and supported by a delivery guide so that the filler wire passes through the center of, and is insulated from, the induction coil. The induction coil induces a current flow in the filler wire. The current produces heat as a result of the electrical resistivity of the filler wire. The heat produced raises the temperature of the filler wire just before it is fed into the weld arc region, thus reducing the energy required from the welding arc to melt the filler metal wire into the weld puddle.

### RELATED APPLICATION DATA

This application is a continuation-in-part of application Ser. No. 11/755,795 filed on May 31, 2007.

### FIELD AND BACKGROUND OF INVENTION

The hot wire process has been used almost exclusively with gas tungsten arc welding. The hot wire gas tungsten arc welding (GTAW) process is an arc welding process that uses an electric arc between a non-consumable tungsten/tungsten alloy electrode and the work piece to create a molten weld pool. The region immediately around the electrode is protected by the flow of a shielding gas that protects the electrode tip, weld pool, and solidifying weld metal from atmospheric contamination. The arc is produced by passing electrical current from the electrode to the work piece through the conductive ionized shielding gas column. Heat generated from the welding arc is used to melt the base material to form a weld puddle. The electrode can be progressively moved along the surface of the work piece to produce a weld pass. A consumable filler wire is added into the weld puddle to provide material to fill a weld groove or create a weld buildup. For the conventional GTAW process, the energy to melt the filler wire also comes from the heat generated by the welding arc. In the HW-GTAW process variant, the filler wire is pre-heated just prior to its being fed into the welding pool. Preheating reduces the amount of energy needed from the welding arc to melt the filler wire, thereby increasing the efficiency of the process and permitting higher deposition rates of filler wire to be used.

From an industry review, all practical applications for the hot wire process have involved HW-GTAW utilizing a resistive heating technique to preheat the filler wire (see FIG. 1). An electrical contactor is placed in direct contact with the filler wire in close proximity to the weld puddle; current flows through the contactor to the filler wire and into the weld puddle. This current flow preheats the filler wire by the heat produced from the resistivity of the filler material. This technique of preheating requires the end of the filler wire to remain in direct contact with the weld puddle to maintain the electrical circuit for the preheating current.

The current hot wire technique has some limitations. The filler wire must maintain physical contact with the weld puddle to provide a continuous electrical circuit. This requirement restricts the entry position of the filler wire for conventional HW-GTAW to the trailing edge of the weld puddle. The trailing edge (i.e. behind the weld torch) is the position where the weld puddle is most accessible to filler wire.

An alternative hot-wire process has been proposed by Iwamoto (JP408192273A-Appl. No. JP07018762), using a solenoid coil to inductively heat a traveling filler wire for non-consumable electrode type arc welding (FIG. 3). Iwamoto proposed a non-consumable electrode type arc welding device that performs the welding of the base material while the wire-shaped filler (122) is fed into the molten pool (162) generated by the arc (282) generated between a non-consumable electrode (222) and the base metal (242). In addition, the arc welding device is provided with a filler metal heating device (202) that has a solenoid coil (142) that is configured such that a hollow part inside the coil is caused to travel on the filler wire (122), and with a high-frequency power supply that causes a high frequency current to run in the solenoid coil.

The proposed process by Iwamoto offers no practical means to prevent electrical contact between the induction coil and filler wire as well as a means to support/guide the heated filler metal to the desired delivery point, being the welding arc. Induction heating of a wire to suitable temperatures (>1000 F) to benefit the hot wire technique requires the ID surface of the coil to be within close proximity (within approximately 0.150″) of the OD surface of the wire. The wire must also remain centered in the coil to achieve uniform and repeatable heating. The wire and the coil must not come into electrical contact; otherwise, the system will have an electrical short. As the wire is heated there is the tendency for the wire to sag, thereby increasing the risk of an electrical short. The wire is also pushed through the coil on its way to the welding arc. The heating of the wire reduces the axial compression strength of the wire, where there is a tendency to buckle if not fully supported to the delivery point of the welding arc. Buckling promotes the tendency for an electrical short or an interruption in the feed rate of the wire through the coil. An interruption in the wirefeed will result in over-heating of the wire that is delayed within the coil, thereby resulting in melting of the wire and a shutdown of the process.

The approach proposed by Iwamoto for controlling the position of the wire in the coil using guide rolls 146 and 148 is not practical for the process. The guide rolls do not prevent sagging or buckling of the wire heated inside of the coil. Any deformation of the wire during the heating process will result in an increased resistance to being pushed through the exit guide roller 148. This increased resistance in feeding will further promote increased deformation/buckling of the heated wire as a result of the lower axial compression strength. Buckling promotes the tendency for an electrical short or an interruption in the feed rate of the wire through the coil. An interruption in the wirefeed will result in over-heating of the wire that is delayed within the coil, thereby resulting in melting of the wire and a shutdown of the process.

The use of an exit guide roll 148 by Iwamoto to control the wire entry point to the welding arc is also not practical. It is imperative to the process that the exiting filler wire consistently enters the center of the weld arc column; otherwise there will be a termination of the weld process. For commercial applications of the GTAW process, a metallic guide is used, in close proximity to the welding arc, to direct the wire into the arc column. Typically, the guide tip must be within 1-inch of the arc column to consistently place the wire into the arc column. By the inherent design of a set of exit guide rollers the tangent point of the guide roller/wire cannot be positioned within the proximity needed to guide the wire into the arc column without the roller and/or roller support bracket impinging upon the components of the GTA torch or the arc column itself.

### SUMMARY OF INVENTION

The present invention addresses the limitations in the known art and is drawn to an improvement of the hot wire welding process. This inherent problem (mentioned in the above paragraph) solved by the proposed invention is the use of a ceramic guide tube inside of the induction coil and wire delivery guide. Here, an induction coil is used to preheat the filler metal prior to its entering the welding puddle/arc region. An induction coil is placed in close proximity to the welding arc. The filler wire is guided by a ceramic insulator so that the filler wire passes through the center of the induction coil while remaining electrically isolated from the induction coil. The ceramic insulator also prevents heat loss and high temperature corrosion (galling) from the preheated filler wire and the typical metallic guide used to direct the filler wire into the welding arc. The ceramic insulator must possess unique properties. It must have high thermal shock resistance, high elevated temperature wear resistance, high mechanical strength, and must not become conductive at elevated temperatures. Only silicon nitride ceramic has been found to be suitable for the proposed application.

The induction coil induces a current flow in the filler wire. The current produces heat as a result of the electrical resistivity of the filler wire. The heat produced raises the temperature of the filler wire just before it is fed into the weld arc region, thus reducing the energy required from the welding arc to melt the filler metal into the weld puddle.

The various features of novelty which characterize the invention are pointed out with particularity in the claims annexed to and forming part of this disclosure. For a better understanding of the present invention, and the operating advantages attained by its use, reference is made to the accompanying drawings and descriptive matter, forming a part of this disclosure, in which a preferred embodiment of the invention is illustrated as configured for, but not limited to, the gas tungsten arc process. The proposed induction heating process is applicable to consumable electrode, non-consumable electrode, and non-electrode welding processes such as Laser beam Welding, Gas Metal Arc Welding, Submerged Arc Welding, etc.

### BRIEF DESCRIPTION OF THE DRAWINGS

In the accompanying drawings, forming a part of this specification, and in which reference numerals shown in the drawings designate like or corresponding parts throughout the same:

FIGS. 1 and 3 illustrate the prior art Hot Wire Gas Tungsten Arc Welding arrangements.

FIG. 2 illustrates the arrangement of the invention.

### DESCRIPTION OF THE PREFERRED EMBODIMENT

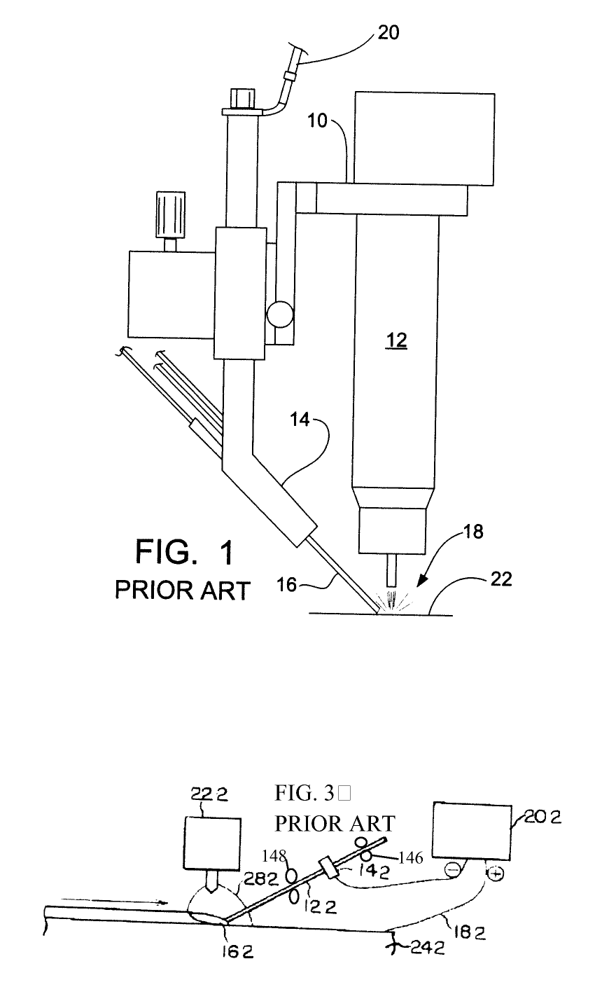

The prior art arrangement for HW-GTAW (hot wire gas tungsten arc welding) is illustrated in FIGS. 1 and 3. For FIG. 1, a framework 10 supports the gas tungsten arc torch 12, and a delivery guide 14 for the filler metal wire 16. The delivery guide 14 is used to guide the filler metal wire 16 to the area of the welding arc 18 adjacent the gas tungsten arc torch 12. Means for delivering electrical current to the filler metal wire 16 is supported on the framework. An electrical cable 20 is provided with an electrical contact that is in contact with the filler metal wire 16 in the delivery guide 14 in close proximity to the welding arc 18 to deliver a current into the filler wire 16. The electrical current preheats the wire 16 before it reaches the welding arc 18 as long as the filler wire 16 maintains a closed electrical circuit by remaining in contact with the weld puddle on the work piece 22.

For FIG. 3, a solenoid coil is used to inductively heat a traveling filler wire for non-consumable electrode type arc welding of the base material while the wire-shaped filler (122) is fed into the molten pool (162) generated by the arc (282) generated between a non-consumable electrode (222) and the base metal (242). In addition, the arc welding device is provided with a filler metal heating device (202) that has a solenoid coil (142) that is configured such that a hollow part inside the coil is caused to travel on the filler wire (122), and with a high-frequency power supply that causes a high frequency current to run in the solenoid coil.

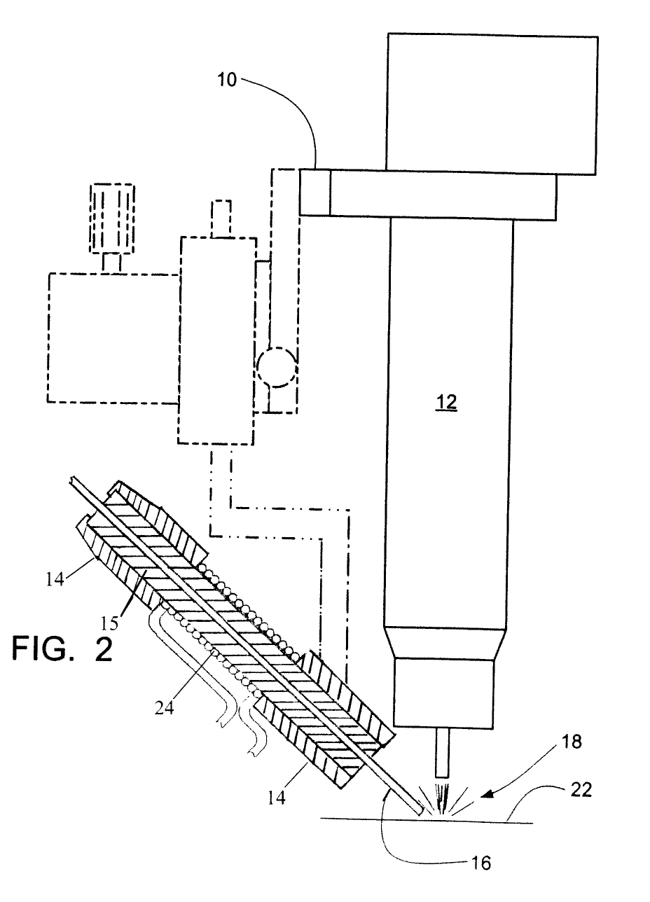

FIG. 2 illustrates the arrangement of the invention as configured for Hot wire Gas Tungsten Arc Welding. The framework 10, gas tungsten arc torch 12, ceramic delivery guide 14, and filler metal wire 16 all are used in the same manner as the prior art. The difference from the prior art is that a means (ceramic guide/insulator 15) is used to electrically isolate the filler wire 16 from the induction coil 24, maintain the filler wire 16 in the center of the coil ID for uniform heating, support the filler wire 16 after heating to prevent buckling, and prevent both heat loss and high temperature corrosion (galling) from the preheated filler wire 16 and the typical metallic guide used to direct the filler wire 16 into the welding arc 18. The induction coil 24 preheats the filler wire 16 before it comes into the area of the welding arc 18.

In the preferred embodiment, a circular induction coil 24 is held in position by the delivery guide 14 such that the induction coil 24 surrounds, but is not in contact with, the filler metal wire 16. A ceramic guide/insulator 15 is used to prevent electrical contact with the solenoid coil 24 while maintaining the filler wire 16 in the center of the coil ID for uniform heating. The ceramic insulator 14 also prevents buckling of the preheated filler wire 16 from the axial load used to feed the filler wire 16 through the process. The ceramic insulator 15 also minimizes heat loss and high temperature corrosion (galling) from the preheated filler wire 16 and the typical metallic guide used to direct the filler wire 16 into the welding arc 18. The induction coil 24 is connected to an electrical current source, not shown, that delivers a current through the induction coil 24. The current through the induction coil 24 induces a magnetic field in the immediate area of the coil. The magnetic field affects the filler metal wire 16 by inducing an electrical current in the filler metal wire 16. The natural electrical resistance of the metal wire 16 results in the creation of heat in the metal wire 16 that serves to preheat and soften the filler metal wire 16 before it enters the area of the welding arc 18. The end result is that less energy from the welding arc 18 is required to melt the filler metal wire 16 into the weld pool on the work piece 22.

As an alternate embodiment, the induction coil 24 may be of a non-circular shape and be positioned adjacent to, but not surrounding the metal filler wire 16.

The invention was conceived as a means of overcoming the limitation of the conventional HW-GTAW process where the filler wire must maintain physical contact with the weld puddle to provide a continuous electrical circuit. The invention eliminates the need for direct contact with the weld puddle, thereby providing complete freedom on the entry position of the filler wire. Wire entry position can now be based upon the requirements and needs of the specific application being welded.

This invention of heating a filler wire for welding using an induction coil provides the same advantages as described for gas tungsten arc welding to other welding process such as, but not limited to, submerged arc welding.

The advantages of the invention, as compared to conventional HW-GTAW, include the following.

The induction heating system eliminates the need for a continuous electrical circuit between the filler wire and the weld puddle. By eliminating this requirement, the process permits the user to choose from a variety of positions for the entry of the filler wire into the weld puddle/arc column. The filler wire can be fed into the leading edge of the puddle, from the side, from the back and any off-angle position desired. In addition, the filler wire can be fed in above the puddle into the arc column itself.

The invention eliminates the formation of magnetic arc blow as a result of current flowing between the filler wire and the weld puddle.

The invention eliminates electrical erosion of the wire guide as a result of micro-arcing that occurs between the sliding contact of the filler wire and the guide for conventional HW-GTAW.

To create a sound weld, the welding arc must provide sufficient energy to raise the temperature of both the base and weld filler materials to their respective melting temperatures and create a common weld puddle. For a given set of welding conditions (amperage, voltage, travel speed, etc.) there is an optimal feed rate for the filler wire, where the deposition rate is maximized while still having sufficient energy from the arc to melt the surrounding base material to produce a sound weld. If the filler metal feed rate is increased beyond this critical point the arc will no longer have enough energy to melt all of the material (base and/or filler). By preheating the filler metal just prior to its entry into the weld puddle, less energy is required from the arc to raise the temperature of the filler wire to its melting point. Thus, for a given set of welding conditions, additional filler metal can be melted using the hot wire induction arrangement (as compared to cold wire) before the welding process reaches the critical point for poor weld quality.

While specific embodiments and/or details of the invention have been shown and described above to illustrate the application of the principles of the invention, it is understood that this invention may be embodied as more fully described in the claims, or as otherwise known by those skilled in the art (including any and all equivalents), without departing from such principles.

What is claimed as invention is:

1. In an improved hot wire welding process where a filler metal passes through a delivery guide to the area of the welding arc, the improvement comprising:
a. an induction coil adjacent the filler metal that induces a current in the filler metal, producing heat in the filler metal; and
b. said delivery guide supporting the filler metal and electrically isolating the filler metal from the induction coil.

2. The improved hot wire welding arrangement of claim 1, wherein the induction coil surrounds the filler metal.

3. The improved hot wire welding arrangement of claim 2, wherein the induction coil is circular.

4. The improved hot wire welding arrangement of claim 1, wherein the induction coil is located in close proximity to the welding arc.

5. In an improved hot wire gas tungsten arc welding arrangement having a gas tungsten arc torch that produces a welding arc and a filler metal that passes through a delivery guide to the area of the welding arc, the improvement comprising:
a. an induction coil that is located in close proximity to the welding arc, surrounds the filler metal, and induces a current in the filler metal, producing heat in the filler metal; and
b. said delivery guide supporting the filler metal and electrically isolating the filler metal from the induction coil.

6. A hot wire welding arrangement, comprising:
a. a gas tungsten arc torch having an electrode that creates a welding arc and a weld puddle during welding operation;
b. an induction coil located in close proximity to the welding arc, but not in contact with the weld puddle, and surrounding the wire whereby it induces a current and heat in the wire; and
c. a ceramic delivery guide that receives and supports the wire and electrically isolates the wire from the induction coil.
